(19) United States
(12) Patent Application Publication
(10) Pub. No.: US 2026/0097995 A1
(43) Pub. Date: Apr. 9, 2026

(54) COMPRESSED AEROGEL COMPOSITE AND METHOD OF MAKING

(71) Applicant: ASPEN AEROGELS, INC., Northborough, MA (US)

(72) Inventors: Owen Evans, Northborough, MA (US); Kathryn Dekrafft, Northborough, MA (US); David Mihalcik, Northborough, MA (US); Sean Depner, Northborough, MA (US)

(21) Appl. No.: 19/113,839

(22) PCT Filed: Oct. 12, 2023
(86) PCT No.: PCT/US2023/035035

§ 371 Date: Mar. 20, 2025

(51) Int. Cl. C04B 35/80; C04B 35/624; C04B 35/645; C04B 38/00

(52) U.S. Cl. CPC C04B 35/80; C04B 35/624; C04B 35/645; C04B 38/0045; C04B 38/0054; C04B 2235/3418; C04B 2235/3826; C04B 2235/483; C04B 2235/5232; C04B 2235/656; C04B 2235/9607

(57) ABSTRACT

The present disclosure relates to a method of producing an aerogel composite, the method includes compressing an aerogel composite, the aerogel composite including a gel dispersed about a reinforcing component. The method further includes heating the aerogel composite. The method further results in producing a compressed and heated aerogel composite, the produced aerogel composite comprising a plurality of pores, a. majority of which having a diameter less than 50 nm.

### CROSS-REFERENCE TO RELATED APPLICATION

This application claims the benefit of priority to U.S. Provisional Patent Application Ser. No. 63/415,897 entitled “COMPRESSED AEROGEL COMPOSITE AND METHOD OF MAKING,” filed Oct. 13, 2022, the disclosure of which is incorporated herein in its entirety by reference.

### BACKGROUND

Low-density materials have been developed to solve a number of thermal isolation problems where the insulation core material experiences high pressures. For instance, polymeric materials have been compounded with hollow glass microspheres to create syntactic foams, which are typically very stiff, compression resistant materials. Syntactic materials are well known as insulators for underwater oil and gas pipelines and support equipment. However, syntactic materials are relatively inflexible and exhibit high thermal conductivity relative to flexible aerogel composites (aerogel matrices reinforced by fibers.)

Aerogels describe a class of material based upon their structure, namely low density, open cell structures, large surface areas (often 900 m²/g or higher) and sub-micron scale pore sizes. Supercritical and subcritical fluid extraction technologies are commonly used to extract the solvent from the fragile cells of the material. A variety of different aerogel compositions, both organic and inorganic are known in the art. Inorganic aerogels are generally based on metal alkoxides and include materials such as silica, zirconia, titania, alumina, carbides and many others. Organic aerogels can include carbon aerogels and polymeric aerogels such as polyimides aerogels.

### SUMMARY

The present disclosure relates to a method of producing an aerogel composite, the method includes compressing an aerogel composite, the aerogel composite including a gel dispersed about a reinforcing component. The method further includes heating the aerogel composite. The method further results in producing a compressed and heated aerogel composite, the produced aerogel composite comprising a plurality of pores, a majority of which having a diameter less than 50 nm.

The present disclosure further relates to a method of producing an aerogel composite, the method includes compressing an aerogel composite, the aerogel composite including a silica gel dispersed about a reinforcing component, comprising a polyethylene terephthalate fiber. The method further includes heating the aerogel composite to a temperature above a glass transition temperature of the polyethylene, polyacrylonitrile, an oxidized polyacrylonitrile, polyethylene terephthalate, or a mixture thereof. The method further results in producing a compressed and heated aerogel composite, the produced aerogel composite comprising a plurality of pores, a majority of which having a diameter less than 50 nm.

The present disclosure further relates of a compressed aerogel composite. The compressed aerogel composite includes a gel comprising a metal oxide compound distributed about a reinforcing component. The aerogel composite includes a plurality of pores, the majority of which having a diameter less than 50 nm and a thickness of a aerogel composite is less than about 0.6 mm.

The present disclosure further relates of a compressed aerogel composite. The compressed aerogel composite includes a gel comprising a silica distributed about a polyethylene terephthalate fiber reinforcing component. The aerogel composite includes a plurality of pores, the majority of which having a diameter less than 50 nm.

### BRIEF DESCRIPTION OF THE FIGURES

The drawings illustrate generally, by way of example, but not by way of limitation, various aspects of the present disclosure.

FIG. 1 illustrates a compression mechanism where a hydraulic press is used to densify an aerogel composite.

FIG. 2 is a continuous compression scheme for densification of an aerogel composite.

FIG. 3 is a graph showing the thermal conductivity of the gel for the aerogel composite of Example 1 at different levels of compression.

FIG. 4 is a graph showing the thermal performance vs. stress in the composite aerogel of Example 1.

FIG. 5 is a graph showing the thermal conductivity of the composite aerogel of Example 1 at various temperatures.

FIG. 6A is a graph illustrating a decrease in thermal conductivity of the composite aerogel.

FIG. 6B is a graph showing the average pore size of the composite aerogel of Example 1 at various degrees of permanent strain.

FIG. 7 is a graph showing the pore size distribution in the composite aerogel of Example 1 at various degrees of permeant strain.

FIG. 8 is a graph illustrating the limited proportion of applied strain that is retained in the aerogel composite upon application of a compressive strain.

FIG. 9A illustrates that lower silica density in the aerogel composite and higher compressive strain are both associated with higher plastic strain in an aerogel composite.

FIG. 9B illustrates that hydrophobic content (covalently bonded to silica aerogel in a reinforced silica aerogel composite) is another parameter than can alter the amount of plastic deformation retained in the aerogel composite in response to a compressive strain.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z.” has the same meaning as “about X, about Y, or about Z,”unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “compression set” as used herein refers to the amount of permanent deformation that occurs when a material is compressed to a specific deformation, for a specified time, at a specific temperature.

### Aerogel Composite Synthesis

The polymers described herein can terminate in any suitable way. In some aspects, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

According to aspects presented herein, improved aerogel composite structures with low thermal conductivity at an increased density can be prepared as well as optimal pore sizes and overall thickness are produced, additionally thermal conductivity, max stress at 50% strain, and compression set of aerogels that are heated and compressed (as opposed to only compressed) can be controlled. This is largely due to the disclosed process that includes compressing the aerogel composite and heating the aerogel composite.

Densified aerogels, especially mechanically densified aerogel composites, can be formed from flexible (non-densified) precursors. Various flexible layers, including flexible fiber-reinforced aerogels, can be readily combined and shaped to give pre-forms that when mechanically compressed along one or more axes, give compressively strong bodies along any of those axes. These densified aerogel bodies exhibit much better thermal insulation values than syntactic foams. Other composite aerogel properties benefiting from mechanical densification, includes increased flexural strength and modulus.

For the sake of convenience the alcogel route of forming inorganic aerogels is used below to illustrate the disclosure, though this is not intended to limit the present disclosure to any specific type of aerogel and/or method of preparation. The disclosure is also applicable to other inorganic-, inorganic/organic-, and organic-aerogels and preparation methods.

Aerogels and aerogel composites suitable for compression and heating can take on a variety of forms including particle-reinforced, fiber-reinforced or unreinforced aerogels, any one of which comprising an organic, inorganic or a hybrid aerogel matrix. An example form is a two phase aerogel composite where the first phase comprises a low-density aerogel matrix and the second comprises a reinforcing material.

In a simple form of fiber-reinforced aerogel composites, a fibrous material is embedded within a matrix material for a variety of reasons, such as improved mechanical performance. The matrix material, can be prepared via sol-gel processing, resulting in a polymeric network (comprising an inorganic, organic, or inorganic/organic hybrid). Fibrous materials combined with a sol prior to the point of polymeric gelation during sol-gel processing reinforce the matrix material. The aerogel matrix of the preferred precursor materials for the present disclosure may be organic, inorganic, or a mixture thereof. The wet gels used to prepare the aerogels may be prepared via any of the gel-forming techniques that are well-known to those skilled in the art: examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3, which is incorporated by reference herein). Examples of materials for forming inorganic aerogels are metal oxides such as silica alumina, titania, zirconia, hafnia, yttria, vanadia and the like. In some aspects, gels can be formed primarily from alcohol solutions of hydrolyzed silicate esters due to their ready availability and low cost.

One synthetic route for the formation of an inorganic aerogel is the hydrolysis and condensation of an appropriate metal alkoxide. The most suitable metal alkoxides are those having about 1 to 6 carbon atoms, from 1-4 carbon atoms, in each alkyl group. Specific examples of such compounds include tetraethoxysilane (TEOS), tetramethoxysilane (TMOS), tetra-n-propoxysilane, aluminum isopropoxide, aluminum sec-butoxide, cerium isopropoxide, hafnium tert-butoxide, magnesium aluminum isopropoxide, yttrium isopropoxide, titanium isopropoxide, zirconium isopropoxide, and the like. In the case of silica precursors, these materials can be partially hydrolyzed and stabilized at low pH as polymers of polysilicic acid esters such as polydiethoxysiloxane. These materials are commercially available in alcohol solution. Pre-polymerized silica precursors are also preferred for the aerogel composites described herein.

Some variables in the inorganic aerogel formation process include the type of alkoxide, solution pH, and alkoxide/alcohol/water ratio. Control of the variables can permit control of the growth and aggregation of the matrix species throughout the transition from the “sol” state to the “gel” state. While properties of the resulting aerogels are strongly affected by the pH of the precursor solution and the molar ratio of the reactants, any pH and any molar ratio that permits the formation of gels may be used in the aspects.

Generally, the solvent for these processes is a lower alcohol, e.g. an alcohol having 1 to 6 carbon atoms, preferably 2 to 4, though other liquids can be used as is known in the art. Examples of other useful liquids include but are not limited to: ethyl acetate, ethyl acetoacetate, acetone, dichloromethane, and the like.

Any of the following methods can be utilized to make a precursor aerogel composite article, but the methods that allow for obtaining the lowest density and/or best thermally insulating articles are desirable. For example, in a first alternative implementation of gel making, a water soluble, basic metal oxide precursor can be gelled by acidification in water to make a hydrogel. Sodium silicate has been widely used for this purpose. Salt by-products may be removed from the silicic acid precursor by ion-exchange and/or by washing subsequently formed gels with water. Removing the water from the pores of the gel can be performed via exchange with a polar organic solvent such as ethanol, methanol, or acetone. The resulting dried aerogel has a structure similar to that directly formed by supercritical extraction of gels made in the same organic solvent. A second alternative method entails reducing the damaging capillary pressure forces at the solvent/pore interface by chemical modification of the matrix materials in their wet gel state via conversion of surface hydroxyl groups to trimethylsilyl ethers (see U.S. Pat. No. 5,877,100 for example) to allow for drying of the aerogel materials at temperatures and pressures below the critical point of the solvent.

Methods of drying gels for generating aerogels or xerogels are well known. Kistler (J. Phys. Chem., 36, 1932, 52-64) describes a drying process where the gel solvent is maintained above its critical pressure and temperature. Due to the absence of any capillary forces, such supercritical drying maintains the structural integrity of the gel. U.S. Pat. No. 4,610,863 describes a process where the gel solvent is exchanged with liquid carbon dioxide and subsequently dried at conditions where carbon dioxide is in a supercritical state. Such conditions are milder than the one described by Kistler. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. U.S. Pat. No. 5,565,142 describes a process where the gel surface is modified such that it is more hydrophobic and stronger so that it can resist any collapse of the structure during ambient or subcritical drying. Surface modified gels are dried at ambient pressures or at pressures below the critical point (subcritical drying). Products obtained from such ambient pressure or subcritical drying are often referred to as xerogels.

Organic aerogels can be made from polyacrylates, polystyrenes, oxidized polyacrylonitrile, polyacrylonitriles, polyurethanes, poly-imides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, agarose, and the like (see for instance C. S. Ashley, C. J. Brinker and D. M. Smith, Journal of Non-Crystalline Solids, volume 285, 2001).

Suitable materials for use in preparing aerogels for use at low temperatures comprise the non-refractory metal alkoxides based on oxide-forming metals. Examples of such metals are silicon and magnesium as well as mixtures thereof. For higher temperature applications, suitable alkoxides are generally refractory metal alkoxides that will form oxides, e.g. such as zirconia, yttria, hafnia, alumina, titania, ceria, and the like, as well as mixtures thereof such as zirconia and yttria. Mixtures of non-refractory metals with refractory metals, such as silicon and/or magnesium with aluminum, may also be used. An advantage of using more than one metal oxide matrix material for the aerogel structure is an enhancement of IR opacification, achieved by providing chemical functional groups that absorb radiation at a wider range of wavelengths. Furthermore, finely dispersed dopants, such as carbon black, titania, iron oxides, silicon carbide, molybdenum silicide, manganese oxides, polydialkylsiloxanes wherein the alkyl groups contain 1 to 4 carbon atoms, and the like, may be added to improve thermal performance at higher temperatures by increasing the opacity of the article to IR transmission. Suitable amounts of such dopants generally range from about 1 to 40% by weight of the finished composite or from about 2 to 10%.

In the aforementioned fiber-reinforced aerogel composites, the reinforcing component can be a fiber reinforcement that is a lofty fibrous structure (batting or web), but may also include individual randomly oriented short microfibers, and woven or non-woven fibers. More particularly, suitable fiber reinforcements are based upon either organic (e.g. thermoplastic polyester, high strength carbon, aramid, high strength oriented polyethylene, etc.), low-temperature inorganic (e.g. metal oxide glasses such as E-glass), or refractory (e.g. silica, alumina, aluminum phosphate, aluminosilicate, etc.) fibers. In general, the fiber can be an inorganic fiber, an organic fiber, a particle, a metal fiber, a metal mesh,, or a mixture thereof.

In some specific examples, the fiber can be a polyethylene terephthalate. The polyethylene terephthalate, can be a bi-composition polyethylene terephthalate fiber comprising an inner core and an outer core, wherein a melting temperature of the inner core is higher than a melting temperature of the outer core.

In some aspects, an inorganic (e.g., alumina, metal) foam or an organic foam (e.g., melamine) may be used in any of the sol chemistries described above to produce a foam-reinforced aerogel composite. A sol and a reinforcing foam may be combined and synthesized into a foam-reinforced composite using any of the sol chemistries and processing techniques described above in the context of fiber-reinforced aerogel composites.

The reinforcing component can be in a range of from about 5 wt % to about 75 wt % of the aerogel composite, about 25 wt % to about 50 wt %. or about 30 wt % to about 40 wt % of the aerogel composite.

Mechanical loads experienced by a composite aerogel can be transmitted through a tough cloth fabric layer to a fastener and into other structures. The mechanical load can be initially experienced by the fabric layer and thereafter transferred onto the aerogel composite. An example of this would be fastening the aerogel composite onto a vehicle chassis or other vehicle component capable of bearing a force (e.g., an interior of a body panel, a firewall, an engine mount, a battery/battery pack housing) to serve as a heat barrier. The process for creating the densified nanoporous bodies of this aspect does not require that densification occur prior to installation in an application environment. Via a securing means (adhesives, tapes, fasteners, etc.) the non-mechanically densified aerogel composite can be secured to a body followed by physical compression which molds the now mechanically densified nanoporous body to the shape of the article. This is a significant advantage for creating insulated or protected articles in the lowest possible volume or cross-sectional area.

In the aforementioned aerogel composites, an increase in density can be defined in a broad fashion as a measurable increase in density and for example a density of the aerogel composite can be increased by a factor of 2 to 20 times or 3 times to 10 times relative to the aerogel composite that is neither compressed nor heated. In these aspects, the density referred to is the “envelope” density of the reinforced aerogel composite. Other types of density measurements, such as the “skeletal” density of an unreinforced aerogel material, may be described in other contexts.

The composite produced can be flexible, durable, and have a low thermal conductivity as well as have good resistance to sintering. The performance of an aerogel composite may be substantially enhanced by incorporating randomly distributed microfibers into the composite, particularly microfibers that will help resist sintering while increasing durability and decreasing dusting. The effect of short fiber reinforcement (microfiber) on the performance of a composite will depend on a number of variables, such as fiber alignment, diameter, length, aspect ratio (fiber length/fiber diameter), strength, modulus, strain to failure, coefficient of thermal expansion, and the strength of the interface between the fiber and the matrix. The microfibers are incorporated into the composite by dispersing them in the gel precursor liquid and then using that liquid to infiltrate the lofty batting.

Suitable microfibers useful herein typically range from 0.1 to 100 μm in diameter, have high aspect ratios (L/d>5 or L/d>100), and are relatively uniformly distributed throughout the composite. Since higher aspect ratios improve composite performance, the longest microfibers possible are desired.

However, the length of the fibers used herein is constrained to avoid (or at least minimize) any filtration by the chosen lofty batting when a microfiber-containing gel precursor is infused into the batting. The microfibers should be short enough to minimize filtration by the lofty batting and long enough to have the maximum possible effect on the thermal and mechanical performance of the resulting composite. The microfibers can have a thermal conductivity of 200 mW/m-K or less to facilitate the formation of low thermal conductivity aerogel composites.

When the microfibers are dispersed in a sol, they often will rapidly settle. To overcome this problem, a suspension or dispersion agent that will not deleteriously effect the gel formation should be added to the sol. Suitable suspension/dispersion agents include solutions of high molecular weight block copolymers with pigment affinic groups (Disperbyk-184 and 192 from BYK-Chemie), and the like. The agents need to be effective during at least the period of time between the dispersion of the microfiber in the gel precursor and the gelation of the sol.

The quantity, type, and/or size and aspect ratio of the microfibers used within a specific aerogel composite may be varied to meet specific tasks. For example, an application may involve insulating regions of different temperatures using a continuous aerogel composite; the composite may be made such that more microfibers will be present in the areas of the composite that will contact the higher temperature regions. Similarly, different microfibers (e.g. different material, different aspect ratio, size) may be incorporated in such areas for best insulation performance. Such microfiber modification may be accomplished by using a variety of suspension agents and/or microfibers to cause the microfibers to settle into the composite at different rates and thus in different locations.

Suitable fibrous materials for forming both the lofty batting and the x-y oriented tensile strengthening layers include any fiber-forming material. Particularly suitable materials include: fiberglass, quartz, polyester (PET), polyethylene, polypropylene, polybenzimid-azole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE) e.g. Spectra™, novoloid resins (Kynol), polyacrylonitrile (PAN), PAN/carbon, and carbon fibers.

The aerogel composite can include one or more additives. For example, the aerogel composite can include boron carbide [B₄C], diatomite, manganese ferrite, MnO, NiO, SnO, Ag₂O, Bi₂O₃, carbon black, titanium oxide, iron titanium oxide, aluminum oxide, zirconium silicate, zirconium oxide, iron (II) oxide, iron (III) oxide, manganese dioxide, iron titanium oxide (ilmenite), chromium oxide, SiC, TIC or WC, TiOSO₄, TiOCl₂, or a mixture thereof. A concentration of the additive can be in a range of from about 0.05 wt % to about 10 wt % of the aerogel composite or about 1 wt % to about 7 wt % of the aerogel composite.

### Aerogels Processed by Concurrent Heating and Compression

In various aspects, aerogel compositions that are concurrently heated during compression produce composites that have a lower thermal conductivity and a more uniform thickness than equivalent composites that are not compressed at all and/or are not heated during the compression operation. More specifically, aspects of composite aerogels that have been heated during compression have a standard deviation in average thickness that may as much as half or a quarter of that of an equivalent material that has compressed but not heated. Additionally in various aspects, aerogel compositions that are concurrently heated during compression produce composites that have a higher max stress at 50% strain than equivalent composites that are not compressed at all and/or are not heated during the compression operation.

Additionally in various aspects, aerogel compositions that are concurrently heated during compression produce composites that have a higher compression strain value than equivalent composites that are not compressed at all and/or are not heated during the compression operation.

Additionally in various aspects, aerogel compositions that are concurrently heated during compression produce composites that have a higher compression set value than equivalent composites that are not compressed at all and/or are not heated during the compression operation.

As shown in the Examples, in many applications the standard deviation for the obtained values is lower than in comparative aerogel composites that are only compressed (e.g., not compressed and heated). This means that the produced aerogel composite can not only have these desired properties but that those properties have a degree of control that cannot be achieved by compression alone. The degree of control is beneficial for general processing of aerogel composites and for specific application such as in electric vehicle battery compartments or other devices that have a low tolerance for error. For example, when using automated assembly systems such as industrial robots to assemble multi-component battery packs, dimensional variation can cause manufacturing system faults. In some examples, poor dimensional control can cause electrolyte pooling (from insufficient external pressure on lithium ion battery cells due to parts that are too thin) or cell rupture (from excessive external pressure on lithium ion battery cells due to parts that are too thick

Aerogel composites may be formed using a hydraulic press.

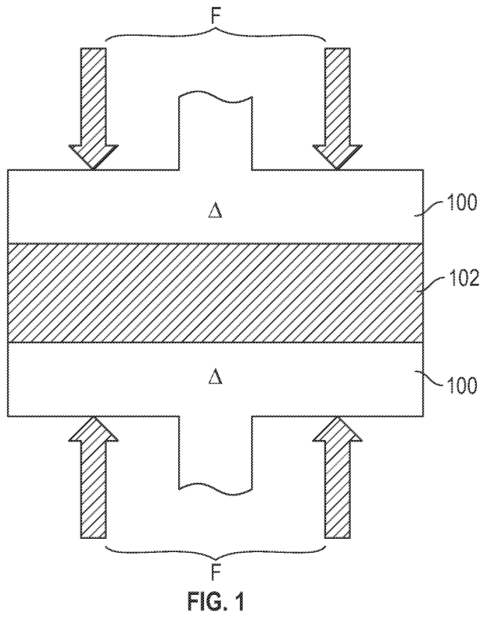

FIG. 1 demonstrates a typical hydraulic press that can be used for mechanical pressing and having two press plates 100 in which the compression force F is applied to press plates by at least one hydraulic press cylinder unit at a location where the cylinder unit is connected to the press plate. The press plates are guided laterally and may be braked by counter support devices. Alternatively, one press plate may be fixed. Thus aerogel 102 is positioned between press plates 100 and subsequently compressed.

In another aspect, densification is achieved via localized compression, provided by continuous action of counter rotating rollers having a clearance (between the rollers) substantially less than the thickness of the uncompressed composite aerogel. Accordingly, the passage of the aerogel composite through said clearance locally compresses the aerogel composite thus resulting in a substantial increase in density.

The aerogels discussed previously may also be densified by passing them between at least one pair of rollers to form sheets with reduced but more uniform thickness and a generally smoother surface. The term “densifed” refers to the process of compressing the aerogel and/or aerogel composite. In this particular aspect compression occurs by passing the aerogel and/or aerogel composite between one or more sets of rollers in order to densify the resulting product. If a series of rollers are used, the roller pairs have successively narrower gaps between them in order to create a progressively denser aerogel and/or aerogel composite and may also have various patterns on their surfaces.

The rollers can be treated in order to prevent adhesion between the aerogel and/or aerogel composite and the rollers. This may be accomplished by coating the rollers with a nonstick substance, polishing the rollers, heating the rollers to form a steam barrier, cooling the rollers to form a condensation barrier or a combination of these.

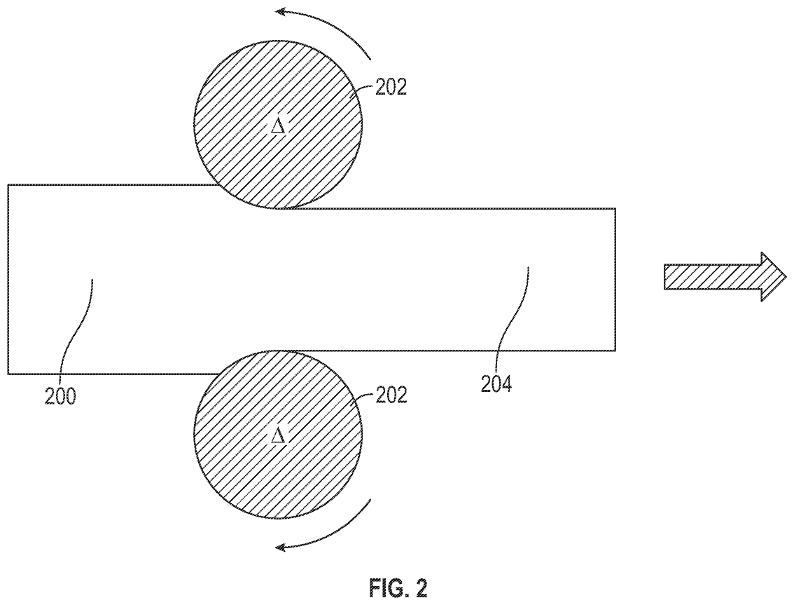

In one aspect, as shown in FIG. 2, it will be desirable to “densify” the aerogel or aerogel composite by passing it between at least one pair of rollers, the purpose of which is to improve the thermal and/or mechanical performance of the aerogel or aerogel composite via densification. In some aspects, the densifying step will only densify aerogel or aerogel composite by a small amount. In other cases, the densification process will substantially densify the aerogel or aerogel composite. In cases where it is desirable to greatly densify the aerogel or aerogel composite, it will often be necessary to densify the aerogel or aerogel composite in steps, wherein the aerogel or aerogel composite is passed through several pairs of rollers each pair having progressively narrower gap distances therebetween.

Reference should be made to FIG. 2 which shows one example in which at least one pair of rollers 202 are employed during the densification step. It should be understood that more than one pair of rollers may be necessary to achieve the desired densification. When more than one pair of rollers are employed, the rollers within each of the roller pairs may have similar diameters, although in some cases it may be preferable to use smaller diameter rollers in combination with larger diameter rollers. As seen in FIG. 2, a set or pair of rollers normally includes two individual rollers 202 positioned adjacent to one another with a predetermined gap distance there between. The gap distance between the two individual rollers corresponds to the desired densification 204 of the aerogel 200 after it passes between the set of rollers.

The press or roller used, can impart a pressure in a range of from about 500 kPa to about 1000 kPa, about 700 kPa to about 1000 kPa, less than, equal to, or greater than about 500 kPa, 600, 700, 800, 900, or about 1000 kPa. The pressure can be constant throughout the process or it can vary. The amount of time that the pressing is conducted over can range from about 0.2 hours to about 24 hours, about 2 hours to about 15 hours, or about 5 hours to about 10 hours.

In an aspect of the present disclosure, the aerogel composite is heated during compression. The application of heat concurrent with the application of pressure is indicated by “D” in FIGS. 1 and 2. As non-limiting examples, the aerogel composite can be heated to a temperature in a range of from about 80° C. to about 700° C., about 90° C. to about 650° C. or 500° C. to about 600° C., or even as low as about 90° C. to about 110° C. Heating can occur simultaneously with compression or following compression. Heating can further occur at a constant temperature or over a gradient of temperatures. The heating can be one cycle or a plurality of heating cycles. Typically, the compression apparatus itself is heated, which imparts the heat to the aerogel composite.

It has been found that if the aerogel composite is concurrently heated and compressed as described herein above, a size of the pores in the aerogel composite can be carefully controlled. Specifically, it was found that a majority (e.g., greater that 50% of the total number of pores) can have a major (e.g., largest) diameter, measured perpendicular to a plane of a major surface of the aerogel composite, less than about 50 nm, less than about 40 nm, less than about 30 nm, less than about 20 nm, in a range of from about 10 nm to about 50 nm or about 20 nm to about 40 nm. Pores in these ranges may provide an optimal low thermal conductivity. That is, pores in these ranges are able to reduce the ability for convective heat transfer through the pores rapidly. The pores are simply too small to allow this. However, the pores are not small enough that the aerogel is densified to such a degree that one would expect an increase conductive heat transfer.

The individual pores can take on many different shapes or profiles. For example, the pores can have an elongated profile. An elongated profile can be understood to be a generally non-spherical or elliptical profile. In some aspects, the profile of the individual pores may have been circular prior to compression and then elongated during compression.

The average thickness of the final aerogel composite, following pressing and heating, is in a range of from about 0.1 mm to about 1.5 mm, about 0.1 mm to about 0.6 mm, 0.1 mm to about 0.5 mm, or about 0.2 mm to about 0.4 mm. A strain of the aerogel composite following its production is in a range of from about 5% to about 40%, about 10% to about 30%, or about 15% to about 20% of the total thickness of the aerogel composite. As understood herein, “strain” refers to the deformation from compression of the heat treated and compressed aerogel composite.

The thermal conductivity of the final aerogel composite can be in a range of from about 13 milliWatts/meter-Kelvin (mW/m-K) to about 60 m W/m-K, about 15 mW/m-K to about 55 mW/m-K, about 20 mW/m-K to about 50 mW/m-K, about 25 mW/m-K to about 45 mW/m-K, about 30 mW/m-K to about 40 m W/m-K.

Without intending to be bound by any theory, it is thought that the heating in addition to compression allows for the formation of the disclosed aerogel composite having the disclosed thickness, pore size, and thermal conductivity. Specifically, it was not considered possible to achieve these values by simply compressing an aerogel composite without the concurrent application of heat. This is because a reinforcing component (e.g., a fibrous reinforcing component) will tend to plastically deform to compensate in response to an applied stress and/or elastically release some/most of applied compression. Release of compression (equivalently, elasticity in the composite) can come from resilience caused by twist in yarn reinforcement; natural resilience/elasticity of a non-woven fabric from the available and variable free space between fibers that permits movement of fibers in response to an applied compressive stress; and/or natural resilience/elasticity in a woven fabric. As recognized by the instant disclosure, adding a heating step that is concurrent with a compressive force overcomes these issues. Benefits of combining heating and compression may include greater precision, consistency and uniformity in a reinforced aerogel thickness that has been simultaneously heated and compressed relative to a same reinforced aerogel composite that has been compressed without heat.

Without intending to be bound by any theory, a mechanism that that may contribute to these advantages is that heating the reinforcing component above a glass transition temperature (for polymers) or other activation temperature allows for the compressed state to be retained after release of pressure. As an example, the reinforcing component may include a bi-composition fiber (e.g., polyethylene terephthalate) comprising an inner core and an outer core, wherein a melting temperature of the inner core is higher than a melting temperature of the outer core. In such a construction the aerogel composite may be heated above the melting temperature of the outer core so that the inner core remains intact while the outer core adheres to the gel. Another explanation, without intending to be bound to any theory, is that the advantageous properties can be achieved because the heat causes reaction between surface groups covalently bonded to aerogel surfaces (e.g., silanol condensation in hydrophobe) that prevents release of applied strain within the aerogel.

With specific reference to the improvements in thermal conductivity, relative to an aerogel composite that is only compressed, and without intending to be bound by any theory can alter the distribution of pore sizes. By reducing a proportion of macropores (e.g., pores having a diameter greater than 50 nm), the thermal conductivity of the composite can be further reduced by reducing the ability of gas molecules to diffuse through the porous aerogel structure. Additionally, compressing an aerogel composite, other than as described herein, can result in an undesirable increase in the aerogel's density that would increase the solid conduction pathways in such an aerogel.

As shown in the Examples herein, aerogels subjected exclusively to compression can provide suitable properties. However, compression and heating generally improves the properties of the aerogels. As shown also, the thickness of the aerogel can be carefully controlled to result in aerogels having desired properties. The control or the thickness and resulting properties of the aerogels having undergone both compression and heating are unexpected to one of ordinary skill in the art, relative to a corresponding aerogel that is only compressed.

### EXAMPLES

Various aspects of the present disclosure can be better understood by reference to the following Examples which are offered by way of illustration. The present disclosure is not limited to the Examples given herein.

### Example 1

A composite aerogel having a thickness of 4.5 mm, a SiC gel and a quartz fiber reinforcing component aged in 0.1 M TMS was produced. Various properties of the composite aerogel are studied.

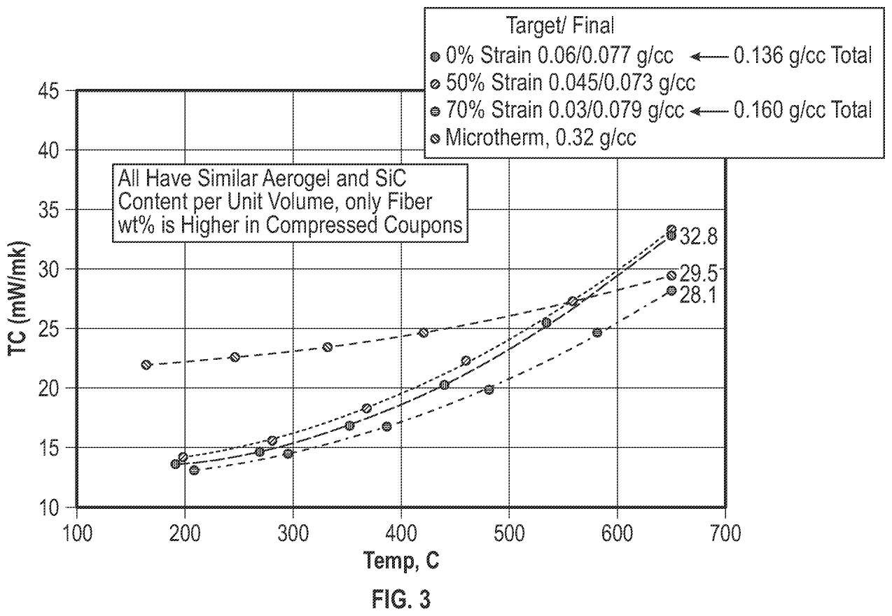

FIG. 3 is a graph showing the thermal conductivity of the gel for the aerogel composite at different levels of compression. As shown the thermal conductivity at high temperatures is lowered when the aerogel composite is compressed to a density from 0.034 g/cc to 0.079 g/cc.

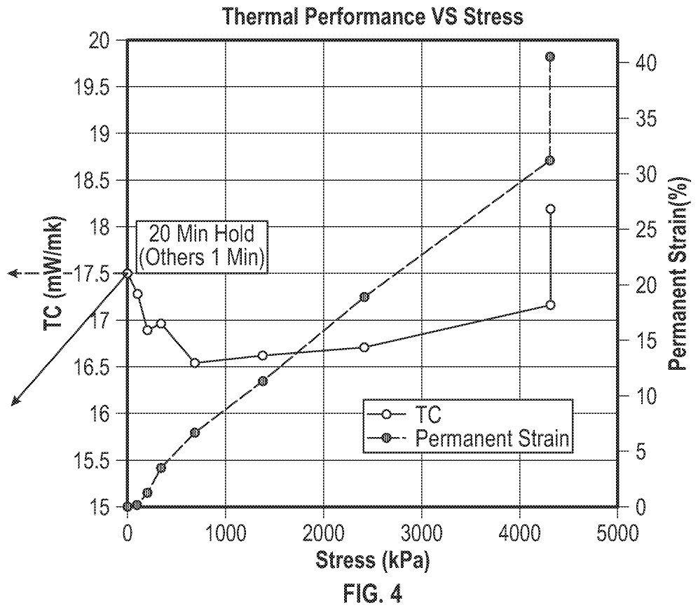

FIG. 4 is a graph showing the thermal performance vs. stress in the composite aerogel of Example 1. As shown thermal conductivity of the aerogel composite is lowered when exposed to a pressure of 4300 kPa.

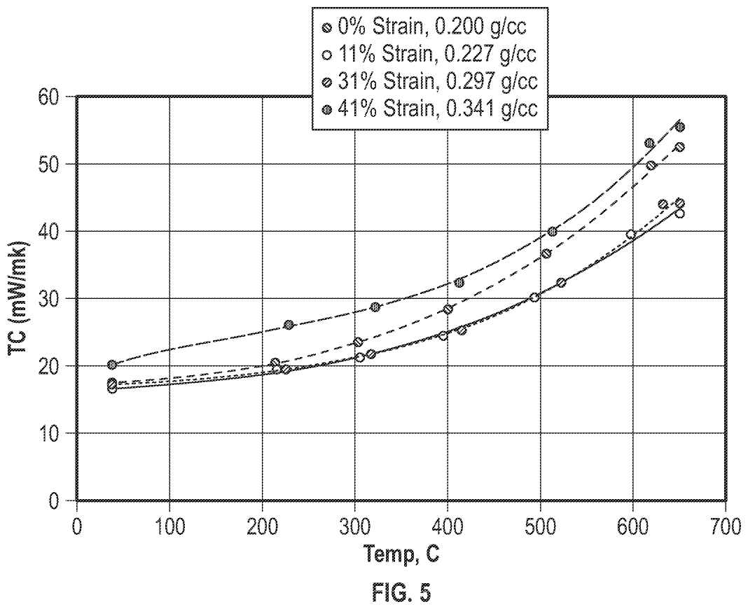

FIG. 5 is a graph showing the thermal conductivity of the composite aerogel of Example 1 at various temperatures. As shown aerogel composites compressed at 11% and 31% strain showed improvement in thermal conductivity relative to an uncompressed aerogel composite.

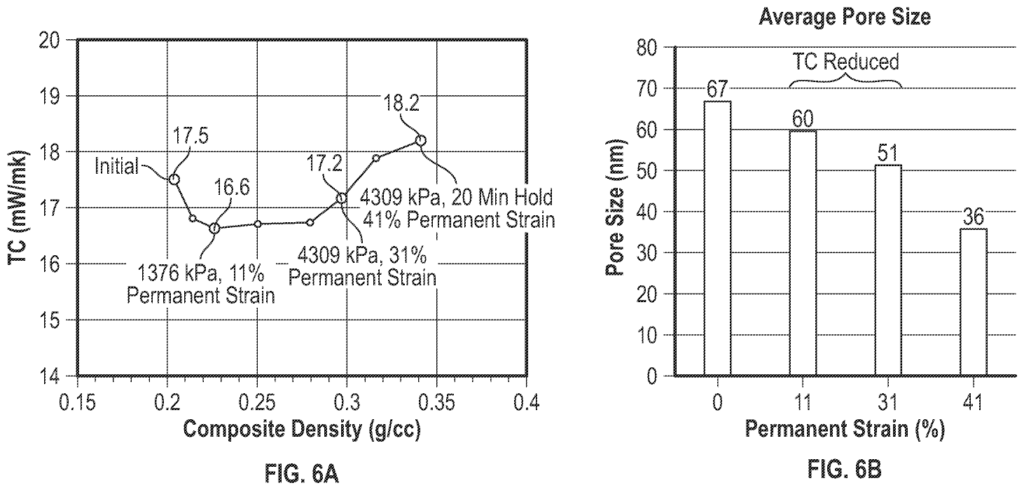

FIG. 6A is a graph illustrating a decrease in thermal conductivity of a composite aerogel with permanent strain of less than 41%.

FIG. 6B is a graph showing the average pore size of the composite aerogel of Example 1 at various degrees of permanent strain. As shown the pore size can be controlled, however beyond 31% strain the pores may become too small.

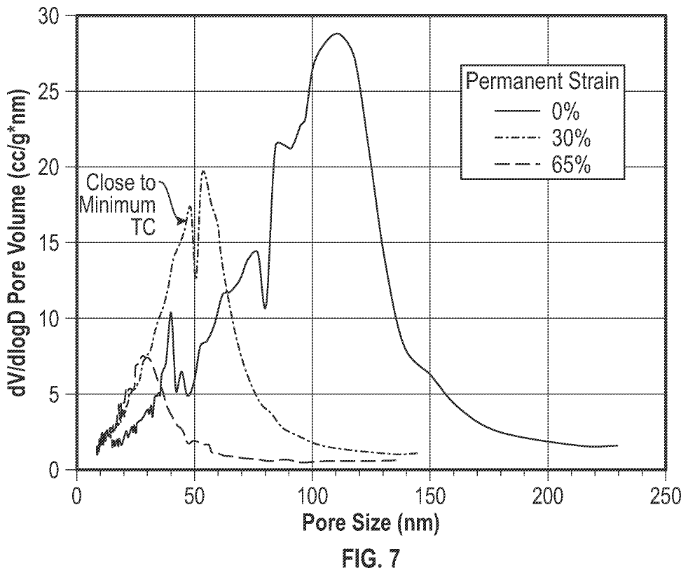

FIG. 7 is a graph showing the pore size distribution in the composite aerogel of Example 1 at various degrees of permeant strain. As shown, the average pore size decreases as the permanent strain is increased.

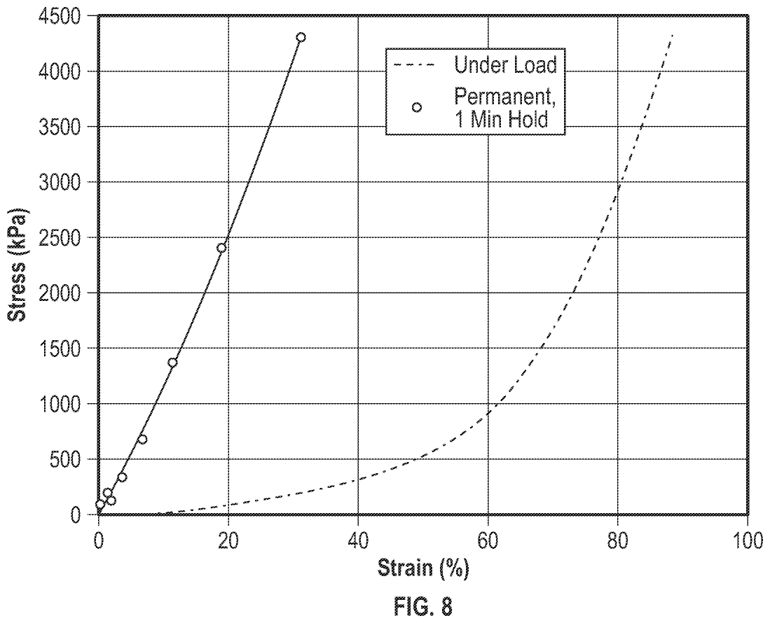

FIG. 8 is a graph illustrating the limited proportion of applied strain that is retained in an aerogel composite upon application of a compressive strain.

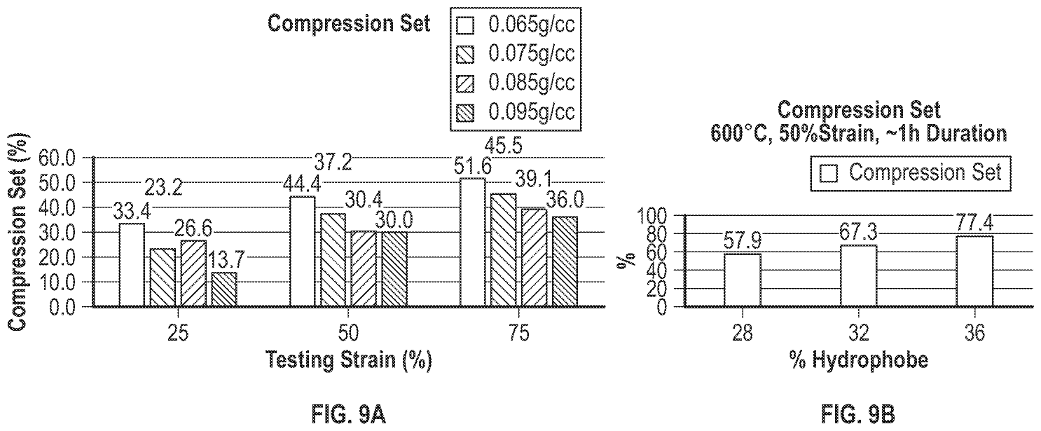

FIG. 9A illustrates that lower silica density in an aerogel composite and higher compressive strain are both associated with higher plastic strain in an aerogel composite.

FIG. 9B illustrates that hydrophobic content (covalently bonded to silica aerogel in a reinforced silica aerogel composite) is another parameter than can alter the amount of plastic deformation retained in an aerogel composite in response to a compressive strain.

### Example 2

A composite aerogel including, octadecyltrimethoxysilane on partially oxidized polyacrylonitrile was produced. An initial density of the aerogel was 0.0825 g/cc with an initial thickness of 2 mm. The density refers to the grams of silica per unit volume of the gel. The target thickness following compression and/or heating was 1.45 mm.

The aerogel was compressed first without heat and achieved a thickness of 1.716 mm with a thickness standard deviation of 0.0998 mm. By comparison when the aerogel was compressed and heated the thickness was 1.62 mm with a thickness standard deviation of 0.05 mm. This shows that compression and heat together a suitable thickness with a degree of control in achieving a target thickness as well as a lower variability in thickness as indicated by a standard deviation that is approximately half of the standard deviation of the unheated, compressed sample. Reduced dimensional (e.g., thickness) variability is important when using aerogel compositions in precision manufactured assemblies (e.g., automotive battery packs) where dimensional tolerances are often in millimeter or sub-millimeter range. All of which would be unexpected relative to a compressed aerogel alone. Thickness values were measured 24 hours after formation.

To better understand the physical properties of the aerogels formed, the max stress at 50% strain was measured for the compressed aerogel as well as the compressed and heated aerogel. The value for the compressed aerogel was 1195.67 kPa with a max stress 50% strain standard deviation of 180.8. The value for the compressed and heated aerogel was 1841.33 kPa with a max stress 50% strain standard deviation of 426.08. This demonstrated that both gels can achieve suitable strength but in particular that a compressed and heated aerogel can exhibit superior and unexpected strength.

A compression set value of the compressed aerogel and the compressed and heated aerogel was determined. It was shown that a compression set of the compressed aerogel was 45.3550% with a compression set standard deviation of 5.72 and the compression set of the compressed and heated aerogel was 50.01383% with a compression set standard deviation of 4.64. This shows that the inelastic component of strain between the gels was statistically the same but that compression alone does not yield the unexpected benefits mentioned herein.

The thermal conductivity of the compressed aerogel and the compressed and heated aerogel was determined. It was shown that the thermal conductivity of the compressed aerogel was 16.011mW/mK with a thermal conductivity standard deviation of 0.0341. The thermal conductivity of the compressed and heated aerogel was 16.089 mW/mK with a thermal conductivity standard deviation of 0.377. This shows the thermal conductivity between the gels was statistically the same but that compression alone does not yield the unexpected benefits mentioned herein.

### Example 3

A composite aerogel including, octadecyltrimethoxysilane on partially oxidized polyacrylonitrile was produced. An initial density of the aerogel was 0.0825 g/cc with an initial thickness of 2 mm. The density refers to the grams of silica per unit volume of the gel. The target thickness following compression and/or heating was 0.92 mm.

The aerogel was compressed first without heat and achieved a thickness of 1.105 mm with a thickness standard deviation of 0.0549 mm. By comparison when the aerogel was compressed and heated the thickness was 1.038 mm with a thickness standard deviation of 0.055 mm. This shows that compression and heat together produce a suitable thickness smaller than what is able to be produced by compression alone. Improved dimensional control (producing a thinner sample) would be unexpected relative to a compressed aerogel alone. Thickness values were measured 24 hours after formation.

To better understand the physical properties of the aerogels formed, the max stress at 50% strain was measured for the compressed aerogel as well as the compressed and heated aerogel. The value for the compressed aerogel was 8780.8 kPa with a max stress 50% strain standard deviation of 1107.10. The value for the compressed and heated aerogel was 10689.8 kPa with a max stress 50% strain standard deviation of 1321.21. This demonstrated that both gels can achieve suitable strength but in particular that a compressed and heated aerogel can exhibit superior and unexpected strength.

A compression set value of the compressed aerogel and the compressed and heated aerogel was determined. It was shown that a compression set of the compressed aerogel was 61.7% with a compression set standard deviation of 4.32 and the compression set of the compressed and heated aerogel was 67.5% with a compression set standard deviation of 1.38. This shows that the inelastic component of strain between the gels was close statistically the same but that compression alone does not yield the unexpected benefits mentioned herein. Indeed, it shows that compression and heat together provide a higher compression set value with a lower standard deviation value.

The thermal conductivity of the compressed aerogel and the compressed and heated aerogel was determined. It was shown that the thermal conductivity of the compressed aerogel was 19.45 mW/mk with a thermal conductivity standard deviation of 0.56. The thermal conductivity of the compressed and heated aerogel was 19.67 mW/mk with a thermal conductivity standard deviation of 0.90. This shows the thermal conductivity between the gels was statistically the same but that compression alone does not yield the unexpected benefits mentioned herein.

### Example 4

A composite aerogel including, octadecyltrimethoxysilane on partially oxidized polyacrylonitrile was produced. An initial density of the aerogel was 0.0825 g/cc with an initial thickness of 1 mm. The density refers to the grams of silica per unit volume of the gel. The target thickness following compression and/or heating was 0.46 mm.

The aerogel was compressed first without heat and achieved a thickness of 0.60 mm with a thickness standard deviation of 0.041 mm. By comparison when the aerogel was compressed and heated the thickness was 0.60 mm with a thickness standard deviation of 0.042 mm. This shows that compression and heat together a suitable thickness with a degree of control in achieving a target thickness as well as a better standard deviation. All of which would be unexpected relative to a compressed aerogel alone. Thickness values were measured 24 hours after formation.

To better understand the physical properties of the aerogels formed, the max stress at 50% strain was measured for the compressed aerogel as well as the compressed and heated aerogel. The value for the compressed aerogel was 20728.7 kPa with a max stress 50% strain standard deviation of 5204.5. The value for the compressed and heated aerogel was 23073.5 kPa with a max stress 50% strain standard deviation of 9828.5. This demonstrated that both gels can achieve suitable strength but in particular that a compressed and heated aerogel can exhibit superior and unexpected strength.

A compression set value of the compressed aerogel and the compressed and heated aerogel was determined. It was shown that a compression set of the compressed aerogel was 56.9% with a compression set standard deviation of 17.9 and the compression set of the compressed and heated aerogel was 29.13% with a compression set standard deviation of 15.58.

The thermal conductivity of the compressed aerogel and the compressed and heated aerogel was determined. It was shown that the thermal conductivity of the compressed aerogel was 15 mW/mK with a thermal conductivity standard deviation of 1.9. The thermal conductivity of the compressed and heated aerogel was 12 mWmK with a thermal conductivity standard deviation of 2.7. This shows the thermal conductivity between the gels was statistically the same but that compression alone does not yield the unexpected benefits mentioned herein.

### Example 5

A composite aerogel including, octadecyltrimethoxysilane on partially oxidized polyacrylonitrile was produced. An initial density of the aerogel was 0.0425 g/cc with an initial thickness of 2 mm. The density refers to the grams of silica per unit volume of the gel. The target thickness following compression and/or heating was 0.92 mm.

The aerogel was compressed first without heat and achieved a thickness of 1.31 mm with a thickness standard deviation of 0.095 mm. By comparison when the aerogel was compressed and heated the thickness was 1.07 mm with a thickness standard deviation of 0.056 mm. This shows that compression and heat together a suitable thickness with a degree of control in achieving a target thickness as well as a better standard deviation, by an order of magnitude. All of which would be unexpected relative to a compressed aerogel alone. Thickness values were measured 24 hours after formation.

To better understand the physical properties of the aerogels formed, the max stress at 50% strain was measured for the compressed aerogel as well as the compressed and heated aerogel. The value for the compressed aerogel was 800.667 kPa with a max stress at 50% strain standard deviation of 288.70. The value for the compressed and heated aerogel was 413.66 kPa with a max stress at 50% strain standard deviation of 72.67. This demonstrated that both gels can achieve suitable strength but in particular that a compressed and heated aerogel can exhibit superior and unexpected strength. Additionally, the compressed and heated gels are a less stressed material. Moreover, the standard deviation between the heated and compressed versus compressed alone was much smaller, indicating a higher degree of control.

A compression set value of the compressed aerogel and the compressed and heated aerogel was determined. It was shown that a compression set of the compressed aerogel was 30.5% with a compression set standard deviation of 6.048 and the compression set of the compressed and heated aerogel was 13.2% with a compression set standard deviation of 2.4. This shows that compression and heat together provide a desirable lower compression set value along with better control as indicated by the lower standard deviation.

The thermal conductivity of the compressed aerogel and the compressed and heated aerogel was determined. It was shown that the thermal conductivity of the compressed aerogel was 19.24 mW/mK with a thermal conductivity standard deviation of 0.41. The thermal conductivity of the compressed and heated aerogel was 18.54 mW/mK with a thermal conductivity standard deviation of 0.49. This shows the thermal conductivity between the gels was statistically the same but that compression alone does not yield the unexpected benefits mentioned herein.

### Example 6

A composite aerogel including, octadecyltrimethoxysilane on partially oxidized polyacrylonitrile was produced. An initial density of the aerogel was 0.0425 g/cc with an initial thickness of 2 mm. The density refers to the grams of silica per unit volume of the gel. The target thickness following compression and/or heating was 0.46 mm.

The aerogel was compressed first without heat and achieved a thickness of 0.85 mm with a thickness standard deviation of 0.011 mm. By comparison when the aerogel was compressed and heated the thickness was 0.62 mm with a thickness standard deviation of 0.08 mm. This shows that compression and heat together a suitable thickness with a degree of control in achieving a target thickness, which would be unexpected relative to a compressed aerogel alone. Thickness values were measured 24 hours after formation.

The thermal conductivity of the compressed aerogel and the compressed and heated aerogel was determined. It was shown that the thermal conductivity of the compressed aerogel was 22.5 mW/mK with a thermal conductivity standard deviation of 0.227. The thermal conductivity of the compressed and heated aerogel was 23.1 mW/mK with a thermal conductivity standard deviation of 0.171. This shows the thermal conductivity between the gels was statistically the same but that compression alone does not yield the unexpected benefits mentioned herein.

In the foregoing examples, thermal conductivity is measured using ASTM C518. In the foregoing examples, stress, strain, and compression were determined using ASTM E3574. Statistical analysis was conducted using a computer program called JMP 17, available from JMP Statistical Discovery LLC, Cary NC.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure has been specifically disclosed by specific aspects and optional features, modification and variation of the concepts herein disclosed may be resorted to by those of ordinary skill in the art, and that such modifications and variations are considered to be within the scope of aspects of the present disclosure.

### EXEMPLARY ASPECTS

The following exemplary aspects are provided, the numbering of which is not to be construed as designating levels of importance:
Aspect 1 provides a method of producing an aerogel composite, the method comprising:
   compressing and heating the aerogel composite, the aerogel composite comprising a gel dispersed about a reinforcing component;
   and
   producing a compressed and heated aerogel composite, the produced aerogel composite comprising a plurality of pores, a majority of which having a diameter less than 50 nm.
Aspect 2 provides the method of Aspect 1, wherein the gel comprises a metal oxide compound.
Aspect 3 provides the method of Aspect 2, wherein the metal oxide compound comprises silica, alumina, titania, ceria, yttria or any combination thereof.
Aspect 4 provides the method of any one of Aspects 2 or 3, wherein the metal oxide compound comprises silica.
Aspect 5 provides the method of any one of Aspects 1-4, wherein the reinforcing component comprises a non-woven material, woven material, loft batting, fibrous batting or any combination thereof.
Aspect 6 provides the method of any one of Aspects 1-5, wherein the reinforcing component comprises an inorganic fiber, an organic fiber, a particle, a metal fiber, a metal mesh, an organic foam, or a mixture thereof.
Aspect 7 provides the method of Aspect 6, wherein the inorganic fiber comprises a glass fiber or a ceramic fiber.
Aspect 8 provides the method of any one of Aspects 6 or 7, wherein the organic fibers comprises polyethylene, an oxidized polyacrylonitrile, polyacrylonitrile, polyethylene terephthalate, or a mixture thereof.
Aspect 9 provides the method of Aspect 8, wherein the reinforcing component comprises a bi-composition polyethylene terephthalate fiber comprising an inner core and an outer core, wherein a melting temperature of the inner core is higher than a melting temperature of the outer core.
Aspect 10 provides the method of any one of Aspects 6-9, wherein the organic foam includes melamine.
Aspect 11 provides the method of any one of Aspects 1-10, wherein the reinforcing component is in a range of from about 5 wt % to about 75 wt % of the aerogel composite.
Aspect 12 provides the method of any one of Aspects 1-11, wherein the reinforcing component is in a range of from about 25 wt % to about 50 wt % of the aerogel composite.
Aspect 13 provides the method of any one of Aspects 1-12, wherein a density of the aerogel composite is increased by a factor of up to 20 relative to the gel prior to compression.
Aspect 14 provides the method of any one of Aspects 1-13, wherein a density of the aerogel composite is increased by a factor of up to 10 relative to the gel prior to compression.
Aspect 15 provides the method of any one of Aspects 1-14, wherein the compressing and heating are performed simultaneously.
Aspect 16 provides the method of any one of Aspects 1-14, wherein heating is performed after compressing.
Aspect 17 provides the method of any one of Aspects 1-16, wherein the compressing comprises mechanical compressing or air compressing.
Aspect 18 provides the method of Aspect 17, wherein the mechanical compressing is accomplished with a compressing apparatus.
Aspect 19 provides the method of Aspect 18, wherein the compressing apparatus comprises a press, a roller, or both.
Aspect 20 provides the method of any one of Aspects 18 or 19, wherein the compressing apparatus is heated.
Aspect 21 provides the method of any one of Aspects 1-20, wherein the gel dispersed about the reinforcing component is heated to a temperature in a range of from about 80° C. to about 700° C.
Aspect 22 provides the method of any one of Aspects 1-21, wherein the gel dispersed about the reinforcing component is heated to a temperature in a range of from about 90° C. to about 110° C.
Aspect 23 provides the method of any one of Aspects 1-22, wherein the heating is performed at a constant temperature.
Aspect 24 provides the method of any one of Aspects 1-23, wherein the heating is performed over a gradient of temperatures.
Aspect 25 provides the method of any one of Aspects 1-24, wherein the heating is performed over a plurality of heating cycles.
Aspect 26 provides the method of any one of Aspects 1-25, wherein compressing the gel dispersed about a reinforcing component is accomplished at a pressure up to about 1000 kPa.
Aspect 27 provides the method of any one of Aspects 1-26, wherein compressing the gel dispersed about a reinforcing component is accomplished at a pressure in a range of from about 500 kPa to about 1000 kPa.
Aspect 28 provides the method of any one of Aspects 1-27, wherein compressing the gel dispersed about a reinforcing component is accomplished at a pressure in a range of from about 700 kPa to about 1000 kPa.
Aspect 29 provides the method of any one of Aspects 1-28, wherein compression occurs over a time period ranging from about 0.2 hours to about 24 hours.
Aspect 30 provides the method of any one of Aspects 1-29, further comprising distributing an additive throughout the gel.
Aspect 31 provides the method of Aspect 30, wherein the additive is in a range of from about 0.05 wt % to about 10 wt % of the aerogel composite.
Aspect 32 provides the method of any one of Aspects 30 or 31, wherein the additive is in a range of from about 1 wt % to about 7 wt % of the aerogel composite.
Aspect 33 provides the method of any one of Aspects 30-32, wherein the additive comprises boron carbide [B₄C], diatomite, manganese ferrite, MnO, NiO, SnO, Ag₂O, Bi₂O₃, carbon black, titanium oxide, iron titanium oxide, aluminum oxide, zirconium silicate, zirconium oxide, iron (II) oxide, iron (III) oxide, manganese dioxide, iron titanium oxide (ilmenite), chromium oxide, SIC, TiC or WC, TiOSO₄, TiOCl₂, or a mixture thereof.
Aspect 34 provides the method of any one of Aspects 1-33, further comprising contacting the produced aerogel composite with a solution comprising ethanol and hexamethyldisiloxane.
Aspect 35 provides the method of any of Aspects 1-34, wherein a thickness standard deviation of the compressed aerogel composite having a thickness of from 1 mm to 1.62 mm is from 0.042 mm to 0.056 mm and in some aspects includes the following:
   1.62 mm with a thickness standard deviation of 0.05 mm;
   1.038 mm with a thickness standard deviation of 0.055 mm;
   0.60 mm with a thickness standard deviation of 0.042 mm;
   1.07 mm with a thickness standard deviation of 0.056 mm; or
   0.62 mm with a thickness standard deviation of 0.08 mm.
Aspect 36 provides the method of any of Aspects 1-35, wherein a max stress at 50% strain standard deviation of the compressed aerogel composite having a max stress 50% strain value from 413.66 kPa to 23073.5 kPa is from 72.67 kPa to 9828.5 kPa and in some aspects includes the following:
   1841.33 kPa with a max stress at 50% strain standard deviation of 426.08;
   10689.8 kPa with a max stress at 50% strain standard deviation of 1321.21;
   23073.5 kPa with a max stress at 50% strain standard deviation of 9828.5; or
   413.66 kPa with a max stress at 50% strain standard deviation of 72.67.
Aspect 37 provides the method of any of Aspects 1-36, wherein a compression set value standard deviation of the compressed aerogel composite having a compression set value from 13% to 68% is from 1.38% to 15.58%, and in some aspects may include the following:
   50.01383% with a compression set standard deviation of 4.64;
   67.5% with a compression set standard deviation of 1.38;
   29.13% with a compression set standard deviation of 15.58; or
   13.2% with a compression set standard deviation of 2.4.
Aspect 38 provides the method of any of Aspects 1-37, wherein a thermal conductivity standard deviation of the compressed aerogel composite having a thermal conductivity from 16 mW/mK to 23.1 mW/mK is from 0.0377 mW/mK to 2.7 mW/mK and in some aspects may include the following:
   16.089 mW/mK with a thermal conductivity standard deviation of 0.0377;
   19.67 mW/mk with a thermal conductivity standard deviation of 0.90;
   12 mWmK with a thermal conductivity standard deviation of 2.7;
   18.54 mW/mK with a thermal conductivity standard deviation of 0.49; or
   23.1 mW/mK with a thermal conductivity standard deviation of 0.171.
Aspect 39 provides the method of any one of Aspects 1-38, wherein a thickness of the produced aerogel composite in a range of from about 0.1 mm about 0.6 mm.
Aspect 40 provides the method of any one of Aspects 1-39, wherein a thickness of the produced aerogel composite in a range of from about 0.1 mm to about 0.5 mm.
Aspect 41 provides a method of producing an aerogel composite, the method comprising:
   compressing and heating the aerogel composite, the aerogel composite comprising a silica gel dispersed about a reinforcing component, comprising polyethylene, an oxidized polyacrylonitrile, polyacrylonitrile, polyethylene terephthalate, or a mixture thereof and heating is performed at a temperature above a glass transition temperature of the polyethylene, an oxidized polyacrylonitrile, polyacrylonitrile, polyethylene terephthalate, or a mixture thereof, and
   producing a compressed and heated aerogel composite, the produced aerogel composite comprising a plurality of pores, a majority of which having a diameter less than 50 nm.
Aspect 42 provides the method of Aspect 41, wherein the reinforcing component comprises a bi-composition polyethylene terephthalate fiber comprising an inner core and an outer core, wherein a melting temperature of the of the inner core is higher than a melting temperature of the outer core.
Aspect 43 provides the method of any one of Aspects 41 or 42, wherein the reinforcing component is in a range of from about 5 wt % to about 75 wt % of the aerogel composite.
Aspect 44 provides the method of any one of Aspects 41-43, wherein a density of the aerogel composite is increased by a factor of up to 20 relative to the gel prior to compression.
Aspect 45 provides the method of any one of Aspects 41-44, wherein a density of the aerogel composite is increased by a factor of up to 10 relative to the gel prior to compression.
Aspect 46 provides the method of any one of Aspects 41-45, wherein the compressing comprises mechanical compressing or air compressing.
Aspect 47 provides the method of Aspect 46, wherein the mechanical compressing is accomplished with a compressing apparatus.
Aspect 48 provides the method of Aspect 47, wherein the compressing apparatus comprises a press, a roller, or both.
Aspect 49 provides the method of any one of Aspects 47 or 48, wherein the compressing apparatus is heated.
Aspect 50 provides the method of any one of Aspects 41-49, wherein the heating is performed at a constant temperature.
Aspect 51 provides the method of any one of Aspects 41-50, wherein the heating is performed over a gradient of temperatures.
Aspect 52 provides the method of any one of Aspects 41-51, wherein the heating is performed over a plurality of heating cycles.
Aspect 53 provides the method of any one of Aspects 41-52, wherein compressing the gel dispersed about a reinforcing component is accomplished at a pressure up to about 1000 kPa.
Aspect 54 provides the method of any one of Aspects 41-53, wherein compressing the gel dispersed about a reinforcing component is accomplished at a pressure in a range of from about 500 kPa to about 1000 kPa.
Aspect 55 provides the method of any one of Aspects 41-54, wherein compressing the gel dispersed about a reinforcing component is accomplished at a pressure in a range of from about 700 kPa to about 1000 kPa.
Aspect 56 provides the method of any one of Aspects 41-55, wherein compression occurs over a time period ranging from about 0.2 hours to about 24 hours.
Aspect 57 provides the method of any one of Aspects 41-56, further comprising distributing an additive about the gel.
Aspect 58 provides the method of Aspect 57, wherein the additive is in a range of from about 0.05 wt % to about 10 wt % of the aerogel composite.
Aspect 59 provides the method of any one of Aspects 57 or 58, wherein the additive is in a range of from about 1 wt % to about 7 wt % of the aerogel composite.
Aspect 60 provides the method of any one of Aspects 57-59, wherein the additive comprises boron carbide [B₄C], diatomite, manganese ferrite, MnO, NiO, SnO, Ag₂O, Bi₂O₃, carbon black, titanium oxide, iron titanium oxide, aluminum oxide, zirconium silicate, zirconium oxide, iron (II) oxide, iron (III) oxide, manganese dioxide, iron titanium oxide (ilmenite), chromium oxide, SiC, TIC or WC, TIOSO₄, TiOCl₂, or a mixture thereof.
Aspect 61 provides the method of any one of Aspects 41-60, further comprising contacting the produced aerogel composite with a solution comprising ethanol and bis(trimethylsilyl)amine.
Aspect 62 provides the method of any of Aspects 41-61, wherein a thickness standard deviation of the compressed aerogel composite having a thickness of from 1 mm to 1.62 mm is from 0.042 mm to 0.056 mm and in some aspects includes is the following:
   1.62 mm with a thickness standard deviation of 0.05 mm;
   1.038 mm with a thickness standard deviation of 0.055 mm;
   0.60 mm with a thickness standard deviation of 0.042 mm;
   1.07 mm with a thickness standard deviation of 0.056 mm; or
   0.62 mm with a thickness standard deviation of 0.08 mm.
Aspect 63 provides the method of any of Aspects 41-62, wherein a max stress at 50% strain standard deviation of the compressed aerogel composite having a max stress 50% strain value from 413.66 kPa to 23073.5 kPa is from 72.67 kPa to 9828.5 kPa and in some aspects includes the following:
   1841.33 kPa with a max stress at 50% strain standard deviation of 426.08;
   10689.8 kPa with a max stress at 50% strain standard deviation of 1321.21;
   23073.5 kPa with a max stress at 50% strain standard deviation of 9828.5; or
   413.66 kPa with a max stress at 50% strain standard deviation of 72.67.
Aspect 64 provides the method of any of Aspects 41-63, wherein a compression set value standard deviation of the compressed aerogel composite having a compression set value from 13% to 68% is from 1.38% to 15.58%, and in some aspects may include the following:
   50.01383% with a compression set standard deviation of 4.64;
   67.5% with a compression set standard deviation of 1.38;
   29.13% with a compression set standard deviation of 15.58; or
   13.2% with a compression set standard deviation of 2.4.
Aspect 65 provides the method of any of Aspects 41-64, wherein a thermal conductivity standard deviation of the compressed aerogel composite having a thermal conductivity from 16 mW/mK to 23.1 mW/mK is from 0.0377 mW/mK to 2.7 mW/mK and in some aspects may include the following:
   16.089 mW/mK with a thermal conductivity standard deviation of 0.0377;
   19.67 mW/mk with a thermal conductivity standard deviation of 0.90;
   12 mWmK with a thermal conductivity standard deviation of 2.7;
   18.54 mW/mK with a thermal conductivity standard deviation of 0.49; or
   23.1 mW/mK with a thermal conductivity standard deviation of 0.171.
Aspect 66 provides the method of any one of Aspects 41-65, wherein a thickness of the produced aerogel composite in a range of from about 0.1 mm to about 0.6 mm.
Aspect 67 provides the method of any one of Aspects 41-66, wherein a thickness of the produced aerogel composite is in a range of from about 0.1 mm to about 0.5 mm.
Aspect 68 provides a compressed aerogel composite, comprising:
   a gel comprising a metal oxide compound distributed about a reinforcing component, wherein
   the aerogel composite comprises a plurality of pores, the majority of which having a diameter less than 50 nm.
Aspect 69 provides the compressed aerogel composite of Aspect 68, wherein a thickness standard deviation of the compressed aerogel composite having a thickness of from 1 mm to 1.62 mm is from 0.042 mm to 0.056 mm and in some aspects includes is the following:
   1.62 mm with a thickness standard deviation of 0.05 mm;
   1.038 mm with a thickness standard deviation of 0.055 mm;
   0.60 mm with a thickness standard deviation of 0.042 mm;
   1.07 mm with a thickness standard deviation of 0.056 mm; or
   0.62 mm with a thickness standard deviation of 0.08 mm.
Aspect 70 provides the compressed aerogel composite of any of Aspects 68 or 69, wherein a max stress at 50% strain standard deviation of the compressed aerogel composite having a max stress 50% strain value from 413.66 kPa to 23073.5 kPa is from 72.67 kPa to 9828.5 kPa and in some aspects includes the following:
   1841.33 kPa with a max stress at 50% strain standard deviation of 426.08;
   10689.8 kPa with a max stress at 50% strain standard deviation of 1321.21;
   23073.5 kPa with a max stress at 50% strain standard deviation of 9828.5; or
   413.66 kPa with a max stress at 50% strain standard deviation of 72.67.
Aspect 71 provides the compressed aerogel composite of any of Aspects 68-70, wherein a compression set value standard deviation of the compressed aerogel composite having a compression set value from 13% to 68% is from 1.38% to 15.58%, and in some aspects may include the following:
   50.01383% with a compression set standard deviation of 4.64;
   67.5% with a compression set standard deviation of 1.38;
   29.13% with a compression set standard deviation of 15,58; or
   13.2% with a compression set standard deviation of 2.4.
Aspect 72 provides the compressed aerogel composite of any of Aspects 68-71, wherein a thermal conductivity standard deviation of the compressed aerogel composite having a thermal conductivity from 16 mW/mK to 23.1 mW/mK is from 0.0377 mW/mK to 2.7 mW/mK and in some aspects may include the following:
   16.089 mW/mK with a thermal conductivity standard deviation of 0.0377;
   19.67 mW/mk with a thermal conductivity standard deviation of 0.90;
   12 mWmK with a thermal conductivity standard deviation of 2.7;
   18.54mW/mK with a thermal conductivity standard deviation of 0.49; or
   23.1 mW/mK with a thermal conductivity standard deviation of 0.171.

1. A method of producing an aerogel composite, the method comprising:
compressing and heating the aerogel composite, the aerogel composite comprising a gel dispersed about a reinforcing component, wherein the compressing and heating are performed simultaneously; and
producing a compressed and heated aerogel composite, the produced aerogel composite comprising a plurality of pores, a majority of which having a diameter less than 50 nm.

2. The method of claim 1, wherein the gel comprises a metal oxide compound.

3. The method of claim 2, wherein the metal oxide compound comprises silica, alumina, titania, ceria, yttria or any combination thereof.

4. The method of claim 2, wherein the metal oxide compound comprises silica.

5. The method of claim 1, wherein the reinforcing component comprises a non-woven material, woven material, fibrous batting or any combination thereof.

6. The method of claim 1, wherein the reinforcing component comprises an inorganic fiber, an organic fiber, a particle, a metal fiber, a metal mesh, an organic foam, or a mixture thereof.

7. The method of claim 6, wherein the inorganic fiber comprises a glass fiber or a ceramic fiber.

8. The method of claim 6, wherein the organic fiber comprises polyethylene, an oxidized polyacrylonitrile, polyacrylonitrile, polyethylene terephthalate, or a mixture thereof.

9. The method of claim 8, wherein the reinforcing component comprises a bi-composition polyethylene terephthalate fiber comprising an inner core and an outer core, wherein a melting temperature of the inner core is higher than a melting temperature of the outer core.

10. The method of claim 6, wherein the organic foam includes melamine.

11. The method of claim 1, wherein:
the reinforcing component is in a range of from about 5 wt % to about 75 wt % of the aerogel composite; or
the reinforcing component is in a range of from about 25 wt % to about 50 wt % of the aerogel composite.

12. (canceled)

13. The method of claim 1, wherein:
a density of the aerogel composite is increased by a factor of up to 20 relative to the gel prior to compression; or
a density of the aerogel composite is increased by a factor of up to 10 relative to the gel prior to compression.

14.-20. (canceled)

21. The method of claim 1, wherein:
the gel dispersed about the reinforcing component is heated to a temperature in a range of from about 80° C. to about 700° C.; or
the gel dispersed about the reinforcing component is heated to a temperature in a range of from about 90° C. to about 110° C.

22.-25. (canceled)

26. The method of claim 1, wherein compressing the gel dispersed about a reinforcing component is accomplished at a pressure up to about 1000 kPa.

27.-33. (canceled)

34. The method of claim 1, further comprising contacting the produced aerogel composite with a solution comprising ethanol and hexamethyldisiloxane.

35. The method of claim 1, wherein a thickness standard deviation of the compressed aerogel composite having a thickness of from 1 mm to 1.62 mm is from 0.42 mm to 0.55 mm.

36. The method of claim 1, wherein a max stress at 50% strain of the compressed aerogel composite is from 413.66 kPa to 23073.5 kPa.

37. The method of claim 1, wherein a compression set value of the compressed aerogel composite is from 13% to 68%.

38. The method of claim 1, wherein a thermal conductivity of the compressed aerogel composite is from 16 mW/mK to 23.1 mW/mK.

39. The method of claim 1, wherein a thickness of the produced aerogel composite in a range of from about 0.1 mm about 0.6 mm.

40.-72. (canceled)
